(19) United States
(12) Patent Application Publication
(10) Pub. No.: US 2011/0041153 A1
(43) Pub. Date: Feb. 17, 2011

(54) CONTENT MANAGEMENT AND DELIVERY METHOD, SYSTEM AND APPARATUS

(76) Inventors: Colin Simon, Leichhardt (AU); Stephen Menzies, Leichhardt (AU)

Correspondence Address: WINSTEAD PC, P.O. BOX 50784, DALLAS, TX, 75201, US

(21) Appl. No.: 12/811,662

(22) PCT Filed: Jan. 5, 2009
(86) PCT No.: PCT/AU2009/000005

§ 371 Date: Sep. 29, 2010

(30) Foreign Application Priority Data
Jan. 3, 2008 (AU) 2008900071
Jan. 8, 2008 (AU) 2008900125
Jan. 8, 2008 (AU) 2008900127
Jan. 25, 2008 (AU) 2008900334
Jan. 25, 2008 (AU) 2008900335
Jan. 29, 2008 (AU) 2008900990
Feb. 1, 2008 (AU) 2008900438

(51) Int. Cl. H04N 7/173; H04N 5/445; A63F 9/24; G06F 15/16

(52) U.S. Cl. 725/46; 725/110; 463/1; 709/204

(57) ABSTRACT

A system, method and apparatus for content management and delivery, and in particular a means for providing specifically targeted advertising to a recipient through the use of advertisement optimisation, via the use of advertisement deletion and insertion based on the recipient's behavioural characteristics.

### INTRODUCTION

The present invention relates to a system, method and apparatus for Content, including a new or improved advertising medium, advertising management and delivery systems, methods and means, and in particular a means for providing specifically targeted advertising to a recipient audience through the use of advertisement optimisation, via the use of advertisement deletion and insertion based on the recipient's behavioural characteristics as collected from a variety of sources, including the recipient's individual selections, and viewing patterns as determined by other techniques such as screen scraping.

The present invention also has application as a new or alternative means for providing (and receiving) social commentary or networking, including talkback or feedback media, advertorial content, reality television content via ITV media.

The present invention further relates to a system, method and apparatus for providing Content including advertising in virtual malls, and in particular a means for providing specifically targeted advertising along with purchasing support via a call centre to a recipient.

The present invention additionally relates to a system, method and apparatus for providing Content including advertising via social networks, and in particular a means for providing specifically targeted advertising to a recipient audience through the use of advertisement optimisation via the use of social networking.

The present invention also has application as a new or alternative means for providing (and receiving) social commentary or networking, including talkback or feedback media, advertorial content, reality television content via convergent television media, as well as a system, method and means for providing interactive educational experiences, and a system, method and means for interactive business-to-business and business-to-consumer goods and services.

A preferred embodiment of the invention will be described hereinafter with reference to this application. However, it will be appreciated that the invention is not limited to this particular field of use.

### PROBLEMS OF THE PRIOR ART

There presently exists a considerable variety of mechanisms for advertising and promoting goods and services over the different media of the internet, television, radio, telephone (e.g. music/promotions on hold), film (e.g. product placement) and print media.

These are disparate means of delivering advertising in which the audience, who are receiving the advertising, may be hostile to the advertising or be in receipt of the advertising at worst, or nonchalant to the advertising at best. Current known means for advertising do not require the audience to be engaged and to participate in the advertising.

Traditional methods of advertising also suffer at least one of the disadvantages of being constrained by:
(a) space—for example, only one (or a very small number of) advertiser(s) can show an advertisement in a chosen medium such as a billboard or a given editorial “slot” (e.g. the back cover or inside front cover of a magazine title);
(b) time—for example, in television advertising, advertisers pay for an advertisement to be broadcast at a specified timeslot. The opportunity to deliver an advertising message to viewers is limited to that precise timeslot and only one advertiser can purchase a single timeslot per television station.
   The advertising message will not be delivered to recipients who:
   (i) do not have the television turned on;
   (ii) have the television tuned to a different station than the station you chosen to broadcast the advertising message; or
   (iii) tune into the correct station but not during the precise timeslot in which the advertising message is broadcast; and/or
(c) proximity to the medium—for example, mobile advertising media such as mobile billboards, bus advertising or other print advertising on vehicles can only reach recipients who are in close physical proximity to the mobile advertisement.

With the emergence of interactive television (ITV), multiple streams of advertising media can be accessed simultaneously by an ITV. This results in a noisy multimedia experience with each advertising medium competing for the audience's attention.

There is a need for an improved means for delivery of advertising, to converge the advertising from disparate sources, and indeed with other ITV Content, and better utilise each different advertising medium in a harmonious symbiotic manner. This is in contrast to the current environment in which multiple advertisements from disparate sources compete for the viewer's attention, thereby detracting from the impact of the advertising and also the pleasure of the ITV viewing experience, to the extent that consumers often prefer to pay for ITV Content rather than to have the viewing experience interrupted with advertising.

The prior art has not fully utilise available delivery platform's features that enable it to be used as a means for converging known advertising media, and to be an advertising medium in its own right, thereby allowing advertising to be delivered in a manner that can be tailored to the individual consumer in a way that known advertising media cannot.

Additionally, disparate sources of information are available to provide the consumer with information. However, these information sources are often a pre-recorded means of providing information. Currently, when a call centre is linked to advertising (i.e. via a 1300 number or the like) the call centre acts as the starting point for the provision of information. This is inefficient, resulting in the caller:
1. having inadequate control over the information received, since call centre information is often scripted for the average request;
2. spending considerable amounts of time with the call centre operator before specific information is received; and
3. receiving poor quality of information being handed over from the call centre since the call centre is only providing on demand access to pre-recorded information without the dynamic exchange of background supporting information.

Additionally, there has being no successful means to incorporate advertising into personal viewing recommendations or events referred by social peers.

The emergence of convergent media (CMedia) has unique features that enable it to be used as a means for converging known advertising media, and to be an advertising medium in its own right, thereby allowing advertising to be delivered in a manner that can be promoteded by social peers and tailored to the individual consumer in a way that known advertising media cannot.

### OBJECT OF THE INVENTION

It is an object of the present invention to overcome or ameliorate at least one of the disadvantages of the prior art, or to provide a useful alternative.

According to one aspect of the invention there is provided a Content management and delivery system for an ITV Platform including:
a. data input means for receiving data from a plurality of data sources including:
   i. a distribution source, including any combination of satellite, free to air and cable TV;
   ii. a network source, including any combination of:
      A. the internet;
      B. a public network;
      C. a private network;
      D. a network device enabling access to communication technologies including:
         I. video on demand (VoD);
         II. telephone (e.g. voice over internet protocol [VoIP]); and
         III. other communication technologies (e.g. instant messaging, file transfer, short message service, video conferencing);
   iii. a data storage medium source, including any combination of:
      A. a DVD;
      B. a blu-ray disk;
      C. a CD;
      D. an iVDR;
      E. a hard drive
   iv. any combination of the above;
b. a data selection and processing means for selecting data from said plurality of data sources and processing selected data;
c. data output means for delivering processed said selected data to a plurality of Display Planes, wherein each said Display Plane is:
   i. individually output via said processor;
   ii. received on a Display Means; and
   iii. independently written to said Display Means
such that data received from a plurality of disparate data sources is enabled to be displayed on one or more Display Planes on a single Display Means and selectively activated (or inactivated) according to preference.
   According to another aspect of the invention there is provided a Content management and delivery apparatus for an ITV Platform including:
a. data input means for receiving data from a plurality of data sources including:
   i. a distribution source, including any combination of satellite, free to air and cable TV;
   ii. a network source, including any combination of:
      A. the internet;
      B. a public network;
      C. a private network;
      D. a network device enabling access to communication technologies including:
         I. video on demand (VoD);
         II. telephone (e.g. voice over internet protocol [VoIP]); and
         III. other communication technologies (e.g. instant messaging, file transfer, short message service, video conferencing);
   iii. a data storage medium source, including any combination of:
      A. a DVD;
      B. a blu-ray disk;
      C. a CD;
      D. an iVDR;
      E. a hard drive
   iv. any combination of the above;
b. a data selection and processing means for selecting data from said plurality of data sources and processing selected data;
c. data output means for delivering processed said selected data to a plurality of Display Planes, wherein each said Display Plane is:
   i. individually output via said processor;
   ii. received on a Display Means; and
   iii. independently written to said Display Means
such that data received from a plurality of disparate data sources is enabled to be displayed on one or more Display Planes on a single Display Means and selectively activated (or inactivated) according to preference.
   According to a further aspect of the invention there is provided a method for Content management and delivery in a social network including the steps of:
(a) seeing the current Content status of a peer in said social network;
(b) accessing data, upon consent, from said peer's:
   (i) behavioural file;
   (ii) message boards;
   (iii) subscribed groups;
   (iv) friends of said peer;
   (v) Content viewing profile of said peer;
   (vi) Content recordings of said peer;
   (vii) Content schedulers of said peer;
   (viii) any combination of the above;
(c) communicating with said peer, including by:
   (i) sending a message to said peer (e.g. by instant messaging or mail)
   (ii) recommending Content to said peer
   (iii) switching Content of said peer
(d) being notified when:
   (i) new information is added by said peer;
   (ii) Content status changes.

The present invention with its wide array of practical embodiments and applications will be better understood with reference to the following description.

### DETAILED DESCRIPTION

### Dictionary of Defined Terms

Table 1 is a dictionary of terms defined according to the invention. Terms defined in Table 1 are denoted with the use of capitalisation throughout the document. If a term is not capitalised then its plain meaning is to be construed, unless otherwise specified.

TABLE 1
Dictionary of defined terms

| Term | Description |
|---|---|
| Content | Content includes: |
| | (a) “programming” or “editorial” content from any media |
| | source (i.e. Content provider), including television, print |
| | or online editions of magazines and newspapers, website |
| | articles, blogs, commentary and the like; |
| | (b) advertising or sponsored content, including |
| | advertisements, sponsored content, product placement |
| | and the like |
| Display | A Display Means is a means for making data such as |
| Means | graphics or video visible to a viewer. A Display Means |
| | includes a television screen or digital display panel, a |
| | computer screen, a mobile phone or PDA screen and the |
| | like |
| Display | A Display Plane can take the form of a graphics plane or a |
| Plane | video plane. Graphics and video planes are the means in |
| | which graphics and video streams, respectively, are |
| | displayed in Display Means such as a television or digital |
| | display panel or computer screen. Depending on the chip |
| | associated with a convergent television and/or digital |
| | display (or associated set-top box) in recent releases, there |
| | are two or more video planes and five or more graphics |
| | planes. For example, set-top boxes with the NXP 8950 |
| | processor carries the streaming and display requirements for |
| | two video planes and five graphics planes. These planes |
| | can reveal data at a rate of 81,000,000 pixels per second and |
| | therefore are a suitable means to occlude and resolve data as |
| | viewing security levels change. |
| ITV | The term “ITV platform” is used as a generic term for a |
| Platform | platform that allows for simultaneous, and/or coordinated |
| | play of, and selective user interaction with, the internet, |
| | television, video on demand (VoD), telephone (including |
| | voice over internet protocol [VoIP] and other technologies |
| | that enable telephone calls to be made over the internet) and |
| | other communication technologies (e.g. instant messaging, |
| | file transfer, short message service, video conferencing). |
| Set Top | The term set top box (STB) is used as a generic term |
| Box | in the sense that a STB is designed to take the form of a |
| | very small configuration similar to the size of a small |
| | mobile phone with a similar user interface to that of the |
| | iPhone ™ or HTC Diamond ™ phone. Likewise, the above |
| | STB can be incorporated directly into known hardware, for |
| | example, a digital Display Plane, remote control device or a |
| | mobile phone. |
| Video | The term “video” as used in this specification |
| | includes IP video sources such as Google, Facebook and |
| | MySpace, video-on-demand (VoD) sources including |
| | subscription and non-subscription, free-to-air video sources, |
| | Digital Video Broadcast (DVB) and video sources |
| | otherwise delivered, using streaming with datagram |
| | protocols, such as the Reliable User Datagram Protocol |
| | (RUDP), or alternative protocols such as Stream Control |
| | Transmission Protocol (SCTP) or Real-time Streaming |
| | Protocol (RTSP), either by authenticated means for VoD |
| | access, along with other files, from within “walled |
| | gardens”, or via anonymous access from a variety of |
| | sources or other means, which due to their Content, |
| | licensing and distribution means are suitable for accessing |
| | and controlling by a convergent television system. |

The elements of preferred embodiments of the invention are now described under the following headings:

Preferred embodiments of the present invention are now described. In the following description, for purposes of explanation, numerous specific details are set forth in order to provide a thorough understanding of the invention. It may be evident, however, that the invention may be practiced without these specific details. In other instances, well-known structures and devices briefly described in order to facilitate describing the invention.

### A New or Improved Means for Content Delivery on an ITV Platform

The inventive apparatus, method and system provide a means for providing Content including advertising on an interactive television (ITV) platform.

A preferred embodiment of the invention includes an ITV platform in the form of a set-top box connected to a Display Means. This enables retrograde fitting of the ITV platform to existing television displays, and in particular to digital television displays. It will be appreciated by those skilled in the art, however, that:
(a) an ITV platform is not limited to use with a television or to an add-on device; and
(b) a “set top box” includes units built into televisions, displays, panels, computers and recording devices taking the form of software and hardware units. The term “set top box” therefore includes built-in versions and other peripheral versions such as computers etcetera.

For example, an ITV device can take the form of a mobile phone, a personal digital assistant (PDA), or any other device with sufficient processing capacity and memory such as an on-board GPS device in a car and the like. The ITV device must be capable of communicating the Content including advertising in a suitable form for the target audience, whether it be in the form of a video, text message, a JPEG, MPEG, sound or other nominated format. Therefore, this invention is not limited to the manifestations described herein.

The preferred embodiment provides a system for managing and delivering Content on an ITV platform, including:
(i) a Set Top Box (STB) or equivalent device housing a processor and associated hardware to enable the processing of media, data and information, including means to select and receive media Content (such as television programs, teletext, Electronic program guide(s) (EPG), video conferencing, VoIP, etcetera), data and other information via either:
   a) conventional uni-directional communication means (satellite, free to air and cable TV); and/or
   b) the internet to request and receive data;
(ii) a Display Means where the data output from the processor is in the form of either an analogue or digital signal to a visual display unit, attached to said Set Top Box, for displaying selected data, such as video streams, wherein the digital display elements are adapted to consumer media viewing and communication enjoyment by having dynamic communication, increased viewing and application selection and satisfactory digital display resolution.

The selected data is output from the processor to one or more Display Planes, which are enabled to be viewed dependant on the user's or advertiser's (or/including a third parties) preferences.

Each data source is enabled to be displayed on one Display Plane. For example, Content from one media source is enabled to be delivered to an individual Display Plane. Content from another source is displayed to a separate Display Plane. The Content from both sources can be viewed on the same Display Means, one source of Content overlaying the other (in its entirety, or positioned and sized depending on preferences set so that both Display Planes can be viewed simultaneously). This local mixing of Content does not require the central mixing of data at a remote server and/or the utilisation of a remote overlay setup for the display of the data/video stream.

This preferred embodiment allows the user to dynamically display one or more sources of data/video Content as required in areas of the display screen that the user (or an advertiser/third party Content provider) specifies. Further, the use of multiple Display Planes for display enables the user to bring forward, backward, make a plane transparent or opaque to protect the display of information displayed on, for example, an underlying plane and/or to move each plane's position and/or size on the screen (or to locks its position and/or size if so desired for information protection purposes). Opaque includes any of form of display of Content including text, video, etcetera other than transparent.

The plurality of planes may be layered or individually positioned so as to optimise the screen. Each plane is enabled to be display on the screen through enabling software.

### Means for Individually Tailored Content Delivery: Direct Marketing to Individuals Using Behavioural Files and Individual Profiles

The preferred embodiment provides a system, method and means for tailoring and coordinating to the individual consumer the choice of:
(a) Content including advertising to be received;
(b) the timing for receipt of the Content including the advertising delivery; and
(c) the medium for receipt (e.g. the consumer or advertiser may choose to divert part or all of Content or an advertisement [e.g. a sales catalogue containing a discount coupon] while watching ITV on a television screen to the consumer's nominated mobile telephone or PDA, or other form of an ITV-enabled device).

### Behavioural File

The present invention utilises ITV technology to enable a convergence of choices regarding Content to be made by both the advertiser (advertiser can include any third party with a specific role and interest in content delivery) and/or the audience. For example, say an individual viewer tunes in to the BBC television program Top Gear or has scheduled the recording of this program on a digital video recorder connected (or built in) to the ITV device. The same viewer (identified for example by a login name and password authentication, a MAC address, an IP address of the ITV device and/or a chip ID such as a GUID) is logged as being a regular visitor (perhaps a subscriber) to the websites of the Australian Financial Review, Business Review Weekly and the Economist. The viewer's:
(a) reading habits suggest that he or she is a high net worth individual;
(b) listening habits which can aid interpretation of the style and cultural aspects of the individual;
(c) television viewing habits suggest an interest in motor vehicles, particularly sports cars; and
(d) any combination of the above.

The ITV platform enables other data about this viewer to be collated, or combined from other sources (such as individual files from other locations), to create an individual profile behavioural file (e.g. by looking at reading habits, television viewing habits and other websites visited, searches conducted, etcetera). The ITV platform, as with other computer-based technology, can be set up with individual log-ins, thereby enabling tailoring to individual log-in profiles at the same IP address. This enables the Content including advertising to be delivered in a synergistically coordinated form for the individual.

A data control means enables the above selection of Content, timing and the medium via control of the following:
(a) said data input means;
(b) said data output means;
(c) a combination of the above,
   such that said selection is enabled to be adjusted according to said behavioural file so that Content delivery to said Display Means, including advertising or sponsored Content, is enabled to be adjusted according to said user's behavioural file.

### Means for Substituting, Modifying, Adding or Deleting Content According to Individual Profile

The present invention provides means, in relation to Content delivered via any communication means to an ITV, to delete, re-fashion, or reinsert the Content or substitute it with alternative Content. This includes substituting advertising and/or re-inserting it into an alternative time slot or placement (repositioned to take account of a reference point other than time) where the recipient is more receptive to the advertising, as determined by:
(a) said user's individual choice(s) (e.g. an express indication by a consumer for an advertising preference, or a request by a consumer for information from an advertiser or to purchase an item); and/or
(b) behavioural information based on a variety of sources, including:
   (i) past viewing habits,
   (ii) purchasing habits;
   (iii) participation in loyalty schemes; and/or
   (iv) information harvested from peers that have communicated with said user, using any of the means interfaced with convergent television, such as instant messaging, voice over IP (VoIP), social network access and other means.

Content or information that is reinserted or substituted with new material in the preferred embodiment is not restricted to the medium that the Content was deleted from. For example, if a free to air broadcast is rebroadcast on an ITV medium via broadband access, and all of the original free to air advertising was deleted, then the substituted advertising may be substituted or re-inserted as a continuous advertisement stream presented on a different video plane at a different time, rather than a video stream inserted into the program. This enables seamless substitution of advertising and integration with editorial (programming) Content to ensure the quality of the viewing experience.

The term “substitution” has been used thus far to refer to substitution in time or other reference point in relation to editorial (programming) Content. However, the preferred embodiment of the invention also enables substitution of Content such as one advertisement with one or more other advertisements. This feature is described in greater detail in the following sections.

### Means to Enable Consumer Participation in Content Delivery

### Premium Content

In addition to substitute Content, such as advertising, as being provided as determined by the advertiser or ITV operator, the preferred embodiment also enables the user to select, when provided a choice, of Content including advertising media and advertisement themes. Content such as advertising media selection may include the user selecting media such as, for example:
(a) an interactive television which incorporates the user's avatar, picture, voice (e.g. via a voice signature located on the behavioural file) or other characteristic of the user into the advertising displayed; or
(b) advertising which reads the user's profile and adapts the advertising to the user's profile contained on the behavioural file. This selection may include a more passive approach where the user's profile is merged without merging the user's image, avatar or voice with the advertising.

For example, a recipient can be offered a selection of Content source (e.g. a major retailer, a specific manufacturer, a Content provider) or a selection of a Content theme such as a premium advertisement theme taking the form of, for example, the following:
(a) luxury cars;
(b) holidays;
(c) action films;
(d) tempting foods; or
(e) advertising source (e.g. major retailer, specific manufacturer),
   all of which the advertiser has spent considerable resources on placing premium advertising into place.
   The selection of what Content such as which advertisement gets selected is a form of Content or advertising democracy where the recipient's participation is gained. For example, premium advertising is a form of advertising which will be given pride of place due to the activity of the recipient selecting from a limited choice. Depending on the user's selection, an advertising time slot or placement position can be substituted with the appropriate advertising (e.g. specified Content or source).

### Non-Premium Content: Consumer Selection of Content

Not all Content providers such as advertisers have the budget or the product to get such “pride of place” positioning. The preferred embodiment also provides a means for increasing consumer participation in a selection of Content/advertising status ranking.

Content or advertising status ranking refers to premium and non-premium Content slots or placements (traditionally non prime-time viewing time slots and placements in programming with poor audience ratings). In a preferred embodiment, ITV operators and advertising agencies are enabled to offer non-premium slots or placements where the Content/advertisement recipient will be given a rebate or discount for watching such Content/advertising. This is a mechanism for attracting viewers to participate in what would traditionally be considered non-premium Content/advertising.

For example, a supermarket chain may be seeking to run a series of high volume low production cost advertisements. As an incentive to viewers to opt in to receive the advertising, the advertiser gives a credit offer (such as a percentage discount or cash rebate at the cash register) to all recipients of such advertisements. When delivered via an ITV platform, the accompanying a credit offer voucher can be delivered directly to the consumer's mobile phone or PDA, or otherwise emailed, saved to the local ITV device hard drive for later recall and so on. The credit offer can be redeemed, for example, when a recipient's identification and coupon rebate code is given at the cash register (whether online or brick-and-mortar) and verified. Such advertising is unlikely to be selected by those who don't shop at the relevant supermarket, who are not interested in receiving a discount or those who would prefer to pay full price rather than receive the advertising. Therefore, the advertising is targeted by the recipient's selection.

The preferred embodiment provides a means for the same programming Content delivered via an ITV platform to carry different Content according to the preference of the viewer or tailored to the viewer's individual profile or behavioural file.

Viewers who do not wish to receive advertising do not receive it; those who are prepared to accept advertising for various reasons. This may be, for example, in exchange for an inducement or because of a particular need in the viewer's personal circumstances such as a viewer wanting to purchase a new car or review bank services on offer in the marketplace may be willing to receive advertising in relation to those particular goods or services during a certain time period.

The rebate allocation means described in this section also enables a charge to be applied to Content, such as a fee per view for VoD, a subscription for access to certain Content, as well as allocating a negative “charge” in the form of a rebate or discount as described above.

### ITV Game Play as a Method for Managing Delivery of Content

The preferred embodiment also provides a further alternative method for managing the Content including the advertisement delivery in the form of “a Content selection” game. Content/advertising recipients can select Content/advertising through an ITV game play such as rolling a dice or guessing an answer. For example, at the relevant Content/advertising time slot or placement position, the ITV viewer is presented with an option: roll the dice (or spin the wheel) and see what Content/advertising you “win”. A poor score results in a “poor” form of Content/advertising. A good score results in a “good” form of Content/advertising. The rating of what is “poor” or “good” Content/advertising is determined by the optimisation matrix that relates to the individual viewer (dependent on behavioural files, individual profile or indicated advertising preferences). A good score ensures the viewer receives the kind of Content/advertising that best matches the individual's profile or selections.

This form of game play to select Content/advertising enables recipient interaction and furthers the reach of the Content/advertisement to all recipients of an ITV by including a collective game play (as teams or playing against peers in a social network) component into the viewing experience. This embodiment utilises advertising or other Content as gaming subject matter and adds a game play inclusion component into the viewing experience.

### Means to Enable Personalisation of Content Through Image Capture and Incorporation of the Viewer

In addition to the information provided by the behavioural file and individual profile of a viewer, the preferred embodiment also provides means for adapting Content/advertising via a camera incorporated into an ITV device for video conferencing and other purposes. The viewer who is the recipient of the Content/advertising can be incorporated, via their image captured by the camera, into the Content/advertising for a variety of uses. For example, the recipient's image can be morphed or rendered into the image of a hypothetical purchaser of the advertised product such as:
a) the driver of a luxury car;
b) the winner of a game; and/or
c) the beneficiary of a clothing “make over”.

The image of the Content/advertising recipient is captured by the ITV camera, with the recipient's movement causing the image to be caught by the camera. In other words, the recipient's movement (possibly combined with other criteria) triggers the ITV camera to capture an image of the recipient's environment and then to hone in on the moving object within the environment (or the object that meets other criteria such as the non-moving object of certain dimensions [human] within a specified distance of another non-moving object of certain dimensions [couch]).

Subsequently, the image is served into Content delivered from a Content/advertisement-server based on the behavioural file characteristics such as age, gender, etcetera. This fusion of data can take place dynamically at, for example, a local hard drive which houses the captured image and incorporates the image into Content/advertisements specifically selected from the Content/advertisement-server based on behavioural file data. Performing the data fusion at the local hard drive would enable the “morphing” or incorporation feature to be provided without communicating the recipient's image (or other relevant data) to the advertiser, which would assist to overcome privacy concerns.

Details for this image incorporation can be dynamically adjusted, again at the local hard drive or other specified location) to match movement or other criteria such as image size (e.g. to meet the relevant dimensions of the advertising image).

### Means to Enable Personalisation of Content Through Screen Scraping Technology

The preferred embodiment has application as a new or alternative means for Content delivery/advertising as well as for providing (and receiving) social commentary or networking, including talkback or feedback media, advertorial content, reality television content via ITV media. This is enabled by the use of “screen scraping” technology on an ITV platform.

Means for Incorporating the Viewer's Environment into Content/Advertising

The preferred embodiment provides means for incorporating an image of a recipient's environment, instead of the recipient, into Content/an advertisement or program. Here the ITV viewer's room can be captured and, for example, if flowers are the subject of the Content/advertisement, a bunch of flowers can be inserted onto the recipient's table. This is enabled by the use of screen scraping which captures the objects in the viewer's room and incorporates additional items into the room, or substitutes known items such as rug, lounge, coffee table or other common room features. Likewise, room re-modeling can take place such as re-rendering the walls, re-modeling the sofa, the insertion of a new lounge or, if dietary advice is the subject of the advertising, then a new body can be inserted onto the lounge, whether or not incorporated onto the recipient's head or a neighbouring body.

### Means for Social Networking or Social Commentary

A further preferred embodiment also provides a new or alternative means for social networking or social commentary via ITV media. This is because the user characteristic incorporation feature enables themes such as dinner with the prime minister to be “aired” on election night. Currently, an ITV viewer can read a blog or forum while watching, say, the events in the tally room on election night. This preferred embodiment provides a means for converging tally room events and blog information, say, so that the viewer, instead of being required to go to disparate and disconnected media to gather the desired information, can view tally room and blog commentary dynamically superimposed in a single video plane such that the blog commentary takes place in interview format rather than verbally (if so desired by the viewer).

The ITV viewer's lounge room, as captured by the ITV camera and screen scraping technology, can be the location of the interview. Alternatively, the interview can take place in the tally room, with the viewer's image incorporated into tally room image. The viewer can pose as the interviewer, while the interviewee can be, say, the prime minister. Alternatively, the viewer can elect to use anonymous figures or unconnected figures. The ITV viewer's blog entries can be spoken directly into the ITV via a microphone, if preferred, or typed and converted into speech for the purposes of viewing the blog in interview format. The mouthpiece of the interviewee is the means for bloggers' commentary to be spoken (converted, say at the ITV local hard drive into speech). Bloggers can be bloggers at large or peers in a social network.

In this way, this embodiment has application as a new or alternative means for providing (and receiving) social commentary or networking, including talkback or feedback media, advertorial content, reality television content via ITV media.

This embodiment enables a user to instruct Content to be delivered to one or more members of a social network at a predetermined time, upon the happening of a specified event or at will. An event can include an occasion (e.g. an election, the finals of the Australian Open, a goal being kicked by a particular team or player in a particular match) or the occurrence of a particular colour dominating a Display Plane, a particular sound or the appearance of a particular trade mark in Content.

### New or Improved Advertising Media

The preferred embodiment allows the enablement of new advertising streams to be opened via the ITV platform. Currently there are legislative restrictions on particular free-to-air or public broadcaster, such as Australia's ABC, to sell advertising to third parties. The preferred embodiment enables the free-to-air broadcast to be redelivered onto a video plane displayed on the ITV digital panel. An example is a Dr Who episode which can be displayed on the ITV digital panel at a time period of, for example, 3 seconds behind the free-to-air broadcast. Simultaneous to this ITV digital panel display is an independent graphics plane which is promoting the sale of, for example, the Dr Who DVDs containing the current, past and future episodes as a box set or as video on demand (VoD). This enables new revenue and advertising streams to be opened for the ABC who can receive revenue from the additional graphics plane sale panel.

The purchase of, say, the Dr Who DVD box set is enabled from the remote control, mobile phone or other device using encrypted key exchange to debit credit sources to enable dynamic purchasing.

The construction of advertising environments is enabled by using the qualities of each medium in a harmonious manner such that the program of interest, for example the Dr Who episode, has the opportunity to separate advertising by duress, which is, for example, filtering the program flow by inserting advertising into the video stream every 5 minutes, or by laying advertising on top of the image (often seen in free-to-air commercial stations where advertising of the next program is inserted as a sub banner or sub text at the base of the viewing screen), but allow separate screens to handle unique elements of the advertising medium. The program can remain undisturbed whilst a separate screen is proposing advertising offers of merchandise.

Additional screens on the ITV digital display provides, for example, background information to the program screening, the user's email and other application are also active. This is more like the multiple displays that are open whilst working on a computer: A word processor application with the user's text may be active in one screen, the internet open in another, and an email application and banking, share transactions etcetera in other screens. In another embodiment there is a hierarchy of screens preset so, for example, the advertising component must be displayed when a program is watched.

The hierarchy of screens showing what advertising is, in a further embodiment, based on a priority listing payment by the advertiser(s). If there is a combination of share trades, holidays and luxury cars been viewed by a user, then the advertiser may pay a premium to have their advertisements listed. In contrast, if the screen is showing Sesame Street, colouring-in games and educational information for two year olds, then the priority of advertising may be excluded or limited to products suitable for the possible recipients such as excursions to the zoo or swim safe advertisements.

### Mood Promotion

The preferred embodiment allows the streaming of the combination, for example, of art and music to take up whole of the ITV digital display. The theme of the digital display can be set for a fast moving conversation, a relaxing evening or pre-event drinks. The images displayed and the accompanying music can be chosen by the recipient, by a network of social peers or by a DJ. The ability for advertising to be subtlety inserted as product placement in the art, as suggestive commentary or by the weighting of a particular product, such as a new music release, or, say, the art chosen is primarily from Museum of Modern Art in New York, which the New York Tourism Bureau pays for the sponsorship of such advertising. Consequently, the use of mood themes can aid receptiveness to, say, contemporary art and themes readily available for sale, as well as music and locations to visit.

### Virtual Communities

The ITV platform allows for interactivity between the viewer and the broadcaster. It also allows for interactivity between the viewer and other viewers, who can be accessed through the internet or other communication platforms.

The benefit of a convergent TV platform is that it facilitates access to all types of media and Content, whether available on free to air broadcast, cable systems, subscription systems, the internet or narrow data-casting. The viewer selects programs by interest, or by selecting program channels. These program channels are enabled to be either packaged by Content providers or intermediaries, or be constructed by the viewer himself.

The ITV platform allows a record of all viewer selections over time and the compilation of preferences, so that the viewer can easily “default” to past preferences. The platform will have a degree of intelligence, constructing those preferences and analysing those preferences by reference to the individual (or, for example, intelligently using the data gathered from the individual's viewing habits and associated data) and also by reference to similar individuals (forming, for example, probabilistic profiles).

The constructed viewer selection, as prompted by the ITV platform through a menu or personalised program guide, will include programs watched by the viewer in the past, but also suggest new programs (broadcast for the first time) which should meet the viewer's interests or preferences. By way of example, a viewer interested in viewing current affairs who consistently watches (say) “Lateline” may be prompted by a menu assembled by the ITV platform, when he initiates a viewing session, to watch the most recent Lateline broadcast (even if the actual program is time shifted to suit the viewer's needs) or a new current affairs program of similar type, available on an internet service.

The ability of viewers to select Content enhances the viewer experience. It also will encourage viewers to share that experience with friends and colleagues. The sharing of the viewer experience could occur by various means, including:
(a) Providing viewer selected program guides to, for example, friends, social peers and/or colleagues;
(b) Constructing personal program guides for distribution, either on a once off basis or on a continuous basis (e.g. “Stephen's Choice Tonight”);
(c) Prompting friends, social peers and/or colleagues to watch a particular program, by an “instant message” service or alert, which would appear within a separate screen on the monitor of the friend or colleague, or within the program list of that friend or colleague as he or she activates their own viewing session; or
(d) Initiating a viewing of the program by friends or colleagues on the friend or colleague's own screen (either within the principal screen or a subsidiary space within that screen).

By way of example, a fan of cricket, watching a test match broadcast free to air, could anticipate a centenary score by his favourite batsman. He could, by prompting the ITV system (through a button on his control box) initiate a “my friends” panel on his screen and then either send a message to a distribution list, urging them to watch the session (as contemplated in (c) above), or actually display the particular cricket match, as a subsidiary session on friends' screen (as contemplated in (d) above). For those friends who were not watching at the time, the relevant session could be recorded within the friend's viewing guide (identified as a broadcast initiated by the first person) or recorded for subsequent viewing by that friend (as contemplated in (b) above).

The embodiment of the system on the ITV platform allows one person, using his set top box, to send a signal to another person using a similar box, so that each viewer initiates his own viewing session, but the second at the prompting of the first. The ITV platform will facilitate that prompting through providing a communication platform which enables Content to be easily tagged, identified and compiled within the recipient's own viewer preferences or programming choices (for example, it will recognise the friend's program suggestion as a component of the viewer's own preferences, or will actually screen the friend's program suggestions on the recipient's own screen, as a component of his or her viewing experience).

There exist similar virtual communities within the internet environment, where a person can construct an on-line “virtual community” within whom he can be in frequent or constant communication. These communities have a number of examples, and include “My Space”. The communities encourage the sharing of information of various sorts, including text, photographs and videos etc. However, the present invention differs from these earlier examples, because the viewer will now share his tastes and preferences, and the virtual community will involve a real time sharing of an entertainment experience. This may have elements similar to the “My Space” example, or to an internet chat room, but will be much more inter-related to the entertainment experience. By way of example, a viewer could link his friends into watching in common a particular program, but then provide commentary on the program itself. To expand upon the example above, the viewer could initiate viewing sessions by friends of a cricket match, and then initiate a wager with those friends as to the score of the player or outcome of the match, or invite those friends to a celebration, if the outcome is achieved.

A methodology or enablement for virtual communities within an interactive TV environment has not previously existed. The present embodiment allows for a complete fusion of entertainment and informational Content, within communities whether broad or narrow. One enablement will be new communities for information sharing, utilising the capabilities of the ITV platform. By way of example, a teacher could direct students to watch a particular documentary, for discussion in class the next day. The teacher could include program notes, as an adjunct to the documentary, and set assignments, and receive responses. The ITV platform would allow confirmation that the student had in fact watched the program, and collate students' responses to the program itself, and to the teacher's questions and assignments. The ITV platform would also permit verification of learning experiences, by providing assistance for authentication of the viewer, and giving the teacher control over the programming (e.g. as convenor of the session, he or she could prevent fast forwarding or editing of the program session).

Interactive communities have been popular in the area of on-line internet games. Similar games could operate, but on a full convergent platform, where participants could import into the game various entertainment or informational references. By way of example, a participant could enter a “virtual room” and, in order to inhabit or decorate that room could select music from a music library. The ITV platform would deliver that selected music Content to whoever entered that particular domain, and also allow other participants to issue invitations through the ITV platform to their friends or colleagues to visit.

Means for Simulating “Word of Mouth” Feedback from Peers in an ITV Setting

Yet further embodiment can be used to keep the ITV viewing experience alive, by inserting or morphing the image of the recipient into one or a series of fantasy, comic, social networking or “anti”-advertisements prepared by network peers or in conjunction with social networking sites, to be run in advertising slots not generally sought after (that is, low-demand advertising slots).

This can enable a further very powerful form of “advertising” which incorporates the simulation of “word of mouth” advertising from a group of close peers (as gleaned from social network profiles) discussing suggested advertising products in the advertisement break.

For example, a group of social peers can individually watch “the game” in separate remote locations. During the ad break, the advertising or other Content can capture all social peers watching “the game” and simulate their presence in the same location (for example, in each recipient's respective lounge room). The topic that is quickly introduced is the suitability of the players' in “the game” running shoes, diet, financial management strategies, health plans and so on. The peers can then interact on the topic and, after suggestive Content, the social peers can request further information or purchase the items of the so-“advertised” topic.

This method can be used in relation to any goods or services whether associated with “the game” or any editorial (programming) Content. For example, it can be used for book clubs (e.g. online, broadcast or televised) members to discuss and recommend books, then enable members or viewers to purchase the suggested titles.

### Means to Converge Advertising: an Optimisation Matrix

The preferred embodiment of this advertising management and delivery and/or re-delivery means enables advertisers to address individual client's wants and desires with greater specificity. The ITV platform provides a system where the “personality” of a particular viewer can be inferred with several means of providing more specific targeting including a degree of probabilistic likelihood, behavioural information and actual recipient (or surrounds) portrayal so as to engage the recipient at a time and in a setting that is acceptable to the recipient. This addresses the current problem of viewers being bombarded by advertising from disparate sources on all media simultaneously at a time when the viewer may have no interest in the goods or services being advertised.

The preferred embodiment provides a means to target a campaign more specifically at a known audience than is currently possible through known advertising media and methods. This is achieved through an “optimisation matrix” through which the currently noisy advertising environment is reduced to present the viewer with a cleaner advertising environment, in which the viewer has the opportunity to be proactive about the advertising received and to glean objective commentary (from peers) about the topic of interest. This provides advertisers the opportunity to have good consumer feedback reach a potential new customer at a time that is relevant to the customer. Conversely, it provides consumers the opportunity to have a say when it counts and to consider feedback from other consumers before making a decision to purchase certain goods or services.

The ITV platform also allows an advertising campaign to be managed across various entertainment media, irrespective of the relevant platform (for example, a single advertising campaign can be co-ordinated across free-to-air TV, cable TV, broadband services (e.g. You Tube), internet services and other streamed media.

### A New or Alternative Method for Selling Advertising

The preferred embodiment also enables an alternative advertising business methodology with differs from those methodologies used by other media, for example:
1. Free-to-air television (TV) sells advertisements on a pre-paid basis, where the advertiser buys time slots in which there is a likelihood that a particular demographic will be viewing; and
2. Internet advertising sells eye balls and click throughs, on the basis of an assumption that a particular website will deliver a demographic, where use is verified against site visitation and the user's progress through the site (i.e. click through).

On the other hand, the preferred embodiment's ITV systems for advertising will work on the basis that the advertiser buys actual views by a specified audience. In its full embodiment, the advertiser is likely to option a specified number of viewers, and pay against verification of the viewer watching the whole or part of an advertisement. This allows sponsorship for particular recipient demographics to take place directly, rather than the current indirect methods currently used by television where historical data states that a portion of viewers in a particular timeslot watching a particular program will consist of a particular demographic. In contrast to this estimate, the preferred embodiment will allow advertisers' access to specific recipients who have logged in on their IPTV (which may be also verified by other activity such as email access being performed simultaneously on a sub-screen by the target recipient).

This advertising can be modelled so that advertising can be sold to many different advertisers depending on what return the advertiser requires or other criteria such as locality. For example, the preferred embodiment can target users accessing ITV through a specific exchange such as the North Sydney exchange differently to those accessing via the Sydney exchange. Therefore, local advertising can be sold. This is enabled by taking advantage of the time shift feature of the ITV platform such that real time delivery is delayed to the extent that enables the relevant viewer profile or other relevant criteria to be assessed, then the appropriate advertisement selected and delivered to the viewer in accordance with the criteria. In this way, a single timeslot in an advertised television program can be sold to many advertisers.

Indeed the concept of a “timeslot” becomes less relevant with the present invention because (again, by taking advantage of the time shift capacity of ITV), advertising material can be inserted at any point in time (or other reference point) in the programming Content. For example, say a viewer is watching a movie on ITV (delivered by any means including free to air, video on demand or internet TV). The viewer's profile indicates a high net worth and an interest in expensive sports cars. The advertiser is BMW. When a BMW appears in the movie, the viewer is presented with an opportunity to click on a link, which brings up the BMW website on a separate screen or that calls a 24 hour telephone sales line via the ITV (through internet telephony, voIP, video conferencing or other means specified by the advertiser or viewer).

Similarly, ITV providers (channels or program producers) can utilise the preferred embodiment to advertise sales of merchandise such as program books, CDs and DVDs or program or music files delivered online. This is particularly useful for public broadcasters prevented from taking advertising revenue from third party advertisers.

The preferred embodiment also enables viewers watching, for example, Bananas in Pyjamas to effect a purchase while watching ITV. A viewer is presented a link (for example, embedded in the opening title and credits of each program episode) that enables the viewer to purchase the series DVDs, for example, while watching the program and without the need to access a separate computer or the telephone.

The purchase can be made securely via the ITV device or an ITV device remote control (including a mobile phone or other wireless or near communications device functioning as a remote control) by clicking on the link and following prompts to finalise the purchase. The link will provide the viewer with the option to purchase by a variety of communication means, including email, the ITV program Content provider website (e.g. the ABC in the case of Bananas in Pyjamas), by direct call to a telephone sales line from the ITV device, instant messaging or other communication means.

The link can be a pop-up window or a more subtle link such as a simple line of text at the bottom of the viewing screen, a link on a separate picture-in-picture (PIP) screen or even a link that only becomes apparent when the viewer moves the remote control device to:
(a) get an index listing of advertised products for this movie;
(b) position the remote's cursor over the car or other item of interest, which then turns the cursor into a symbol to indicate the presence of a link; and/or
(c) request a verbal or text message prompt for a certain advertised good (e.g. by type such as “car” or by source such as “BMW”, “Ferrari”, “any manufacturer” and so on).
   In a further preferred embodiment, a viewer can use an ITV-enabled mobile phone, PDA or other wireless or near communications device (including gaming controller devices) as a remote to control a main ITV device for viewing. In this embodiment, the link can be made by waving the mobile phone, say, over the screen or pointing it in the general direction of the object of interest (here, a BMW car) to see whether it contains a link or to activate and select a link.

### Means for Substitution of Advertising

The preferred embodiment enables advertisers wanting to promote their goods in the same program such as Australian Idol, say, to include or exclude a given target audience. For example, a clothing manufacturer may want to target as many recipients of a particular age and gender, whereas a credit card promoter may wish to bypass this particular age and gender demographic due to it being associated with a higher credit risk. The advertising can be targeted to very specific profiles to enable the addition, deletion or substitution of certain advertising for delivery to particular profiles. Therefore, the credit card advertisement to be aired during Idol in our example can be substituted with an advertisement for Coca-Cola for the specified demographic. If no alternative advertisement has been booked for that particular demographic in that timeslot (or reference point), the time shift facility of ITV enables the credit card advertisement to be deleted without disruption to delivery of the program Content.

In the preferred embodiment the substitution, deletion or addition of advertising to match the viewer's profile takes place at the ITV local hard drive (or other specified location), to enable fast processing and reduce the resources required by ITV program Content providers (channels) serving up editorial and advertising content. It also contains the local viewer's profile data at the local hard drive level (or other secure location discrete from the advertisers), again assisting to address any privacy concerns.

### Means for Delivering Co-Advertising

The preferred embodiment provides a means for delivering co-advertising that is easily enabled. Co-advertising is where, say, an advertisement for a particular brand or source of clothing is accompanied by a credit offer (whether as a discount or cash back voucher or other means) to a particular demographic so as to provide an enhanced sales outcome. The credit offer can be delivered to the ITV device for printing or to another ITV-enabled device in a file format that can be retrieved at call, or to any mobile phone or PDA that can receive the credit offer voucher in a form that can be retrieved at call.

### Means to Differentiate Content Tariffs

The preferred embodiment also uses the ITV platform to enable:
(a) Differentiated fees or tariffs—for example, differentiated advertising tariffs for a specified advertisement to be addressed to different demographics (for example, 10 cents for a 16 year old male but 5 cents for a 40 year old male);
(b) Differentiated tariffs for an advertisement watched in whole, or an advertisement watched at preferred times (that is, by viewer choice before commencement of a selected program);
(c) Advertisements sequenced to particular programs, irrespective of the time viewed. For example, advertisement can be viewed for luxury cars during the viewing of a “Bond 007” classic—the luxury car advertising can be current for a classic film, or product placement can be morphed such that it has both a current “sophisticated” feel, whilst having a “classic” reverence. An example of this would be a 1950's Jaguar morphed into the current Jaguar release such as the Jaguar SK;
(d) Advertisements co-ordinated with particular programs which feature, or are related to the advertised product (that is, with metadata tabs to co-ordinate advertising placement against products featured in the actual program, with pop-up panels or sales promotions appearing on the viewing screen, without interruption to the actual program). This metadata tabbing is enabled through the use of multiple graphics planes which can sit above a video plane and read the metadata feed to the associated codec to both the video plane and the graphics plane. This allows advertising or any other media to be placed onto any viewing platform. This placement of new media onto a graphics plane, sitting over a video plane such that the original video plane was unnoticed, enables the following examples to take place:
   (i) a video on demand (VoD) broadcast can have a product placement screen scraped or meta data tag to have a base screen graphics plane offering a “purchase now” advertisement,
   (ii) a free to air broadcast as received by the ITV can substitute advertising by applying a graphics or video plane, above the free to air broadcast video plane, with alternative advertising; or
   (iii) a video phone conversation talking place with a backdrop of a particular hotel or conference can have the backdrop changed to a preferred advertiser's promotion.
(e) Advertisements which are coordinated throughout a viewer experience (for example, with programmed priority or viewer dominance, and with advertisers paying for selected priorities (for example, the priority to have the first advertisement on commencement of viewing a program, irrespective of program choice).

### Additional Features of the Preferred Embodiment

The ITV platform enables the preferred embodiment to incorporate the additional features:
(a) Advertisers can pre-load advertisements into the hard disk of the box and serve advertisements to specific audience demographics, programs or time sequences;
(b) Advertisers can update the box with new advertisements and new serving instructions, to coordinate an advertising campaign (for example, to increase frequency of advertisements to coincide with a new product launch);
(c) Advertisers can pre-buy priority in programming, irrespective of viewer choice, and can also purchase advertising in a dormant mode (for example, when the viewer is not watching programs, but the screen remains activated, such as when music is being listened to); and
(d) Advertisers can “pay” viewers to accept advertisements, either by subsidising the sale or gift of the ITV (that is, viewers receive a box on the basis that they will accept an advertising menu, as a condition of use of the box) or viewers receive confirmed loyalty bonuses, as a result of either viewing the advertisement (whether in whole or in part) or acknowledging the advertisement.

As to the particular embodiment of the benefit to advertisers described in paragraph (d) immediately above, the ITV will be configured to permit advertisers to endorse stored value cards (or card accreditation technologies of similar kind) to reward viewers who are motivated to purchase by an advertisement. In one embodiment, the ITV would recognise a viewer viewing a particular advertisement, and would be programmed to offer the viewer an incentive (such as a cash rebate) if the viewer purchased the advertised product within a certain time. The viewer could receive confirmation of that offer and entitlement through technology such as the HIRO™ accreditation system; or the ITV could provide confirmation to the merchant, which would automatically confirm the rebate when the viewer used a particular credit card.

The embodiment described in the preceding paragraph is given enablement by the current architecture of the ITV preferred embodiment, which is configured with encryption technology designed to facilitate on-line purchases and other e-commerce transactions. The box provides a secure interactive environment, under which a viewer can simply execute transactions, where the box identifies the viewer through a secure data exchange and encryption system, which provides secure communication of credit card and other information necessary to effect a transaction. These capabilities of the ITV preferred embodiment are utilised in conjunction with an advertising methodology, where the advertiser presents an advertisement, induces the viewer to confirm an interest in or to communicate with the merchant directly (through a click through or reactive communication channel) and to process an order or sale for the particular product.

The capacity of the ITV preferred embodiment therefore allows this new methodology for advertising, and for selling advertisements and managing advertisers. Under this methodology, advertisers would only pay for one of the following:
(a) the delivery of a specified audience (where the advertiser pays per identified and verified viewer);
(b) the delivery of a specified response (where the viewer acknowledges or otherwise acts consistent with viewing the advertisement); or
(c) the delivery of a product order.

Certain features of this new methodology are currently deployed in internet advertising; however, the invention differs from known systems. In internet advertising, the viewer is asked to move from one internet domain to another (for example, the click site effects a change to a new website address). With the convergence of platforms effected through the ITV, the viewer always remains within a single secure environment, but the viewer uses that environment to “invite” the advertiser to deal with him or her. The consequence is that the advertiser has at all times the following:
(a) increased certainty of the communication of the advertising to the recipient; and
(b) the means to pay for specific access directly as opposed to an indirect basis with the traditional advertising model, to establish the cost and payment for advertising.

The ITV platform enables enhanced systems for advertising management, where advertisers deal directly through the ITV platform with viewers and potential recipients, rather than dealing with service providers. By way of example, the advertiser would no longer need to purchase time slots on various competing free to air TV channels, hoping to achieve a particular audience for the advertisement. Now, the advertiser will deal with an advertising manager (or directly with the ITV operator, to purchase an audience profile, irrespective of the media for delivery of the program.

### Means for Obtaining Recipients' Consent

In another embodiment of the invention, an advertising recipient activates a participating ITV device, such as a set-top box, consents to receive advertising in return for a discount or subsidy in subscription ITV services. As discussed in relation to FIG. 4, the consent can be part of the data (160) provided by the advertising recipient (20) upon enrolment into a subscription ITV system or be provided at any other time subsequently. The consent can be a blanket consent to receive all available advertising for which the advertising recipient (20) is eligible, or specific to an advertiser and/or type of service or product.

Recipients (20) are able to withhold or withdraw consent at any time and are therefore enabled to:
(a) limit the amount of advertising to which they are exposed;
(b) to accumulate subscription ITV discounts from one or more advertisers (40);
(c) to use accumulated subscription ITV discounts in accordance with the terms of their agreement(s) with the advertiser (40) and/or the subscription ITV Operator (30). For example, an advertising recipient (20) who uses several subscription ITV services (60) may choose to receive advertising and subscription ITV discounts from a number of advertisers (40) in order to reduce the total burden of daily subscription of ITV services.
(d) If consent (including details of which sources or kinds of advertising will be acceptable to the advertising recipient (20)) is obtained upon enrolment into an subscription ITV system, advertisements (280) can be pre-loaded onto, for example, the subscription ITV set-top box's hard drive prior to purchase by the advertising recipient.
(e) Alternatively, recipients (20) can consent by purchasing pre-paid subscription ITV devices which are enabled to be fitted, for example, into a digital display device or to other programmable devices in a similar manner that pre-paid SIM cards can be purchased for access to mobile telecommunications networks.
(f) In another assembly of the preferred embodiment, subscription ITV operators (30) and advertisers (40) may individually or collectively offer pre-paid subscription ITV devices for sale to recipients, much like a pre-paid mobile telephones. The pre-paid device may be activated by providing a unique number to the subscription ITV operator (30), the advertiser (40) or a third party on either of those party's behalf (that is, the issuer of the pre-paid device). This would be the mechanism for linking the pre-paid device to an individual advertising recipient (20) and obtaining consent. The advertising recipient (20) may also be asked at the time of activation to nominate a preferred advertising format, preferably from a list predetermined by the issuer of the device. Activation may take place, for example, by the advertising recipient sending a text message containing the unique number to the issuer of the device (e.g. an advertiser (40)), by calling the issuer and entering the unique number when prompted or by any other agreed means. An advertisement (280) could subsequently be delivered in the preferred format—for example, video advertisement file sent to the digital television display, mobile phone, personal digital assistant and other programmable device. This arrangement would work in a similar manner to the arrangement shown in FIG. 5. Recipients (20) who activate a pre-paid device will have advertising transmitted to their activated subscription ITV devices (100) when they pass an subscription ITV time period (90). In another arrangement, recipients can provide on-the-spot or ad hoc consent by responding to a prompt delivered by a subscription ITV feature (90). This feature could also be used to deliver interactive advertising, where the Advertising recipient is required to respond to a question by pressing the button or providing a verbal response, which is transmitted back to a computerised network that operates voice recognition software and can analyse the response and take the appropriate next action.
   Advertising with Call Centre Support

### The Virtual Mall

In an alternative embodiment of the invention incorporates an inventive apparatus, method and system to provide advertising in a virtual mall on a medium such as an interactive television (ITV) platform, which allows for the simultaneous play of, and selective user interaction with, the internet, a virtual call centre (which can be a communication to a single assistant or to a central or distributed location made up of many assistants), television, video on demand (VoD), telephone (including voice over internet protocol [VoIP] and other technologies that enable telephone calls to be made over the internet) and other communication technologies (e.g. instant messaging, file transfer, short message service, video conferencing).

This alternative embodiment of the invention includes a virtual mall presented on an ITV platform in the form of a set-top box connected to a television display panel or screen. This enables retrograde fitting of the ITV platform to existing television displays, and in particular to digital television displays, such that the virtual mall is available in the virtual mall viewer's home.

It will be appreciated by those skilled in the art, however, that the virtual mall with its associated interface with call centres and the like are not limited to use with a television or to an add-on device. For example, a virtual mall can take place on a mobile phone, a personal digital assistant (PDA), or any other device with sufficient processing capacity and memory such as an on-board GPS device in a car and the like. The device displaying a virtual mall must be capable of displaying the advertising in a suitable form for the target audience, whether it is in the form of a video, text message, a JPEG, MPEG or other nominated format. Therefore, this invention is not limited to the manifestations described herein.

This embodiment provides improved means for delivery of advertising such that the:
1. advertisement sponsor has marketing rights into the virtual mall,
2. advertisement recipient can interact with the advertising so as to be provided with background material to support the features of the advertised product or service; and
3. the purchasing transactions resulting from the advertising made via personal interaction through a call centre, enabling the handover of all the context and background information of the recipient's prior activities. This nexus between the virtual mall and the call centre allows the call centre staff to be enabled to advise by knowing the context of the call and the background to the call;
   such that there is a complete guided shopping experience.

This guided shopping experience converges the advertising from disparate sources, in both the real and virtual world and indeed with other information sources, such that the utilization of the benefits of each different medium is maximised and interfaced with other mediums in harmonious symbiotic manner.

The preferred embodiment provides a system, method and means for tailoring to the individual consumer the choice of:
(d) advertising to be received;
(e) the timing for receipt of the advertising; and
(f) the medium for receipt (e.g. the consumer or advertiser may choose to divert part or all of an advertisement [e.g. a sales catalogue containing a discount coupon] while watching ITV on a television screen to the consumer's nominated mobile telephone or PDA, or other form of an ITV-enabled device); and
(g) a medium for the recipient to respond to the advertising, either directly via the medium for receipt or indirectly via a call centre, which is linked into the virtual mall to enable the call centre to know exactly the background and context of what the recipient is calling the call centre about.

### Behavioural Files for Use Via a Virtual Mall

The present invention utilises consumer tracking and response technology to enable a convergence of positive advertising to be delivered by both the advertiser to the recipient. For example, when an individual viewer enters a virtual mall this initiates the monitoring of viewing and interactions/events preceding a purchase.

The events that pass a threshold of further enquiry by requesting additional information or spending a threshold period at the advertising location are examples of positive advertising events. In contrast, the events that precede a recipient exiting a shopping mall can be viewed as negative events. Such events may be dependent on other external events and thus are based on statistical weighting. Therefore, such events that lead to purchasers or exits from the mall are statistical indicators of what advertisement/information packages/mediums of communication impact in a positive or negative manner with regard to the specific virtual mall advertising recipient being monitored. The recipient's actions being logged and associated with specific advertising builds a profile of the recipient's behaviour characteristics such as their likes and dislikes with regard to certain criterion. For example, one recipient may have a resulting profile of being a technical, fashion conscious, early adaptor as opposed to a different recipients profile such as a non-technical, late adaptor, price conscious, sports fan. The advertising in the virtual mall can be set to meet these different profiles.

The virtual mall enables data about this viewer to be collated, or combined from other sources (such as purchasing files), to create an individual profile. The virtual mall, as with other computer-based technology, can be set up with individual log-ins, thereby enabling tailoring to individual log-in profiles at the same IP address.

### Advertisements and Information Provided Based on Behavioural Characteristics

The present invention provides means, in relation to advertising delivered via any communication means to a virtual mall, to delete, refashion, or reinsert the advertising or substitute it with alternative advertising.

Advertising or information that is reinserted or substituted with new material in the preferred embodiment.

The preferred embodiment allows the behavioural profile to be used by advertising bureau to place advertisements forward into advertising mediums such that, for example, the cost is carried by the advertising house. Only when an advertisement is watched, leads to a purchasing transaction, or leads to a referral, does the advertising bureau recoup the expenditure back from creating and running the advertising. The expenditure is recouped from the distributor of the product and/or the manufacturer of the product or other party involved in the success of having a greater reach of a product or service through the market place leading to a greater niche of the market.

The advantage of this form of advertising is that the specialist advertising bureaus can remain specialist and use techniques that lead to sales without the limitations that are currently in place with the advertising sponsor approving or disapproving of the advertising. The advertising bureau is also able to trial advertising directly instead of putting the extensive resources into a pitch that may, or may not, lead to any return.

The advertising sponsor is in the advantageous position of have a greater number of advertisements trialed increasing the products exposure to the market, and a greater number of unique advertisements created to meet specific profiles.

The consumer has the advantage of immediately providing a response back to the advertising bureau to indicate a like or dislike of the advertising such that the disliked advertisement will not be shown to that recipient again.

Consequently, the preferred embodiment allows for the advertisement recipient to control the receipt of advertisement in the same way as they are in control of selection of programs currently on television (in Australia this is in the order of four to seven). The advertising recipient can “sell” back to advertising bureau data what advertising was watched, for how long, and was a purchase made. Further information such as what indicators led to recipients skipping specific advertising can be gathered.

### Assistance to Purchase or to Provide Information

In an additional preferred embodiment a purchaser or an information enquirer in a virtual mall can be assisted with the purchase via a call centre such as an online ITV call centre which is personalized by animated assistants who serve the customer (previously, the advertising recipient). This enables the merchant, adverting sponsor or other party to extend their brand via the persona of the virtual assistant. This virtual assistant can modify its identity to meet the profile of the positive attributes collected from the advertising recipient's profile. This virtual assistance can have the features currently displayed as avatars and can lead to employment of shop assistants in the virtual world via major merchants.

The shop assistant who serves the majority of customers can aid the selection of certain branding over other forms of branding and can be cloned in the virtual world as required.

The call centre assistants that have the most favourable features (manner, style, figure, character, response, intellect and so on) to elicit the most favourable consumer response for each recipient profile can be selected and can be evolved when, and if, required. There can also be a series of favourable features to work on specific profiles and to evolve at different rates with different recipient profiles.

The assistant can also be tailored to other data within the user's behavioural file (e.g. interests, preferences) as well as other specified criteria including:
(a) time;
(b) an event;
(c) expertise;
(d) interest;
(e) subject matter;
(f) any combination of the above.

The inventors recognise that the virtual mall linked to a ITV platform and call centre, has unique features that enable it to be used as a means for converging known advertising mediums to open a recipient's interest in a product and/or service, and to have a call center's assisting staff to close the transaction, thereby allowing the complete shopping experience to be delivered in a manner that can be tailored to the individual consumer in a way that known mediums cannot.

The closing of the transaction, via the call centre's assisting staff, can show the benefits of products along with the supporting information for such statements in alignment with the recipient's requirements, since the supporting staff are enabled to be present as an avatar or as an animated assistant in the virtual mall.

Virtual Mall Interface with a Call Centre

The virtual mall can reside in any virtual manifestation to be displayed on a computer or ITV which for example, via a set-top box, instructs the call centre to respond according to the desired consumer preferences to suit the customer. For example, the Irish customer receives an Irish accent to an Irish character (the new avatar or animated assistant). The call centre is enabled to access the private data of the advertising recipient/consumer/caller during the engagement with the call centre solely for that receiving the handover of the recipient/consumer/caller profile preferences which can reside and be served, for example, from the set-top box.

Because the set-top box identifies the customer, the call centre assistant is enabled to personally address the customer by the details that have been provided by recipient. For example, the recipient may be referred to by their true name or a preferred alias. Further, the avatar/animated assistant is enabled to draw on past data to make the experience more personal and reduce the costs of the call centre. For example, the call centre's animated assistant can responds to a recipient's request for a product request by asking “do you prefer the same as last time or can I interest you in an alternative?”

Details for the avatar or animated assistant's image incorporation can be dynamically adjusted, with information housed on the local hard drive (or other specified location) to match criteria such as preferred features by the recipient and branding features provided by the call centre, advertiser or other party.

The virtual mall incorporated into the ITV platform and linked to a call centre enables an enhanced system for advertising management and purchasing by recipients directly through the ITV platform.

### Advertising Via Social Networks

An additional further embodiment of the inventive apparatus, method and system provide a means for advertising on a convergent television (CMedia) platform utilising social network referral. A CMedia platform allows for simultaneous play of, and selective user interaction with, the internet, television, video on demand (VoD), telephone (including voice over internet protocol [VoIP] and other technologies that enable telephone calls to be made over the internet) and other communication technologies (e.g. instant messaging, file transfer, short message service, video conferencing).

A preferred embodiment of the invention includes a CMedia platform in the form of a convergent set-top box (cSTB) connected to a television or computer display panel or screen. This enables retrograde fitting of the CMedia platform to existing television displays, and in particular to digital television displays. It will be appreciated by those skilled in the art, however, that a CMedia platform is not limited to use with a television or to an add-on device such as a set top box linked to a television. For example, a CMedia device can take the form of a mobile phone, a personal digital assistant (PDA), a chip built in to a CMedia, mobile phone or other electronic device, or any other device with sufficient processing capacity and memory such as an on-board GPS device in a car and the like. The only limitation is that CMedia device must be capable of delivering the advertising in a suitable form for the target audience, whether it is in the form of a video, text message, a JPEG, MPEG, sound file, or other nominated format. Therefore, this invention is not limited to the manifestations described herein.

In one embodiment, the convergent set top box (cSTB) acts as a central gateway for all communication media within the home or office. This is in contrast to the existing setup where, for example, a modem is required for access to the internet, a set top box is required for personal video recording services and an analogue telephone adapter (ATA) is required for voice-over-IP services, and other devices including a computer for running specific applications such as web browser, word processing or spreadsheet software.

The convergent set-top box can replace all these devices, including a computer, since many of the software applications and files can be run remotely or housed on a central server running an application such as the “Google Docs” which provides the means for documents to be created and shared by multiple users who have been given access to the documents by the owner of the documents.

Social Networking Means to “Share the Moment”

This embodiment provides a system, method and means for providing the social networking capability of sharing an event, music clip, document, video, photograph and other forms of media or combinations of media, which will be referred to as “Share the Moment” or STM.

In one example, a viewer Alice uses the preferred embodiment to record an episode of a program, say West Wing, which is aired on television. Alice mentions the previous week's episode of West Wing to her friend Bob while she is talking to Bob on the telephone. He says he did not see that episode. Alice sends a message to Bob with a link to the specific episode, West Wing Episode 1. Alice's message can be sent by using a mobile phone or a remote control device to enter the message into the cSTB so that it is received by a CMedia device in Bob's home. The message can be in any format, such as a voice message, a text message, an email, an instant message, or other communication format that can be delivered over the internet. In one embodiment, the cSTB or remote control device used for the cSTB has a “Share the Moment” button that provides a shortcut method of sending and/or receiving an STM “packet” message (with a link or attachment if and when required).

Bob's message is received either directly, or via forwarding, to his cSTB, which is linked to a digital display panel. The message from Alice is interpreted by the cSTB. The cSTB loads the specific episode of West Wing into the electronic program guide (EPG), under the heading of “Alice's suggestions” with possibly the unique identifier of Alice being the mobile number that Alice sent the text message from. Similarly, the unique identifier can be Alice's email address, which can also contained information regarding a “West Wing” episode which can be interpreted by the cSTB to load the program into Bob's EPG. Alice's communication means such as her mobile number, email address etcetera can be in an address book such that Alice is uniquely identified no matter what the means of communication are used to send an STM event to Bob.

In the SMS example, the SMS is limited to 112 characters. Therefore, the specific episode of West Wing may have a unique identifier and/or the means to interpret the West Wing episode by referencing Alice's behavioural file, which the means to specifically retrieve the most likely West Wing Episode that Alice is referring.

The behavioural file contains information on the cSTB from data that is collected about a particular viewer via a personal cSTB login device. The enables data to be collected and/or collated, and/or combined from other sources, to create an individual profile (e.g. by looking at reading habits, television viewing habits, websites visited, searches conducted, social peer groups, forums, VoIP calls and other communications, etcetera). The CMedia platform, as with other computer-based technology, is set up with individual log-ins, thereby enabling tailoring to individual log-in profiles at the same IP address.

The profile that the user uses to login to his or her cSTB programming is linked to that user's behaviourial file, which is updated with information as to what the profile owner watches and listens to (or what the user exits from watching and listening to). This enables the advertising to be molded to individual preferences. This allows the set-top box to deliver programming based on behavioural file information.

The specific STM event to be retrieved, which in this example is “West Wing Episode 1” is referenced by the cSTB to a reference server were a unique identifier is enabled to connect with information from Alice referral to Bob's EPG, so as to load that specific episode of West Wing.

The set-top box, on receiving the text message can communicate with the reference server, or a mirror of the reference server, to retrieve that specific episode of West Wing and load it into Bob's EPG as Alice's suggestions.

A further embodiment enables the means to exchange STM or broader categories of data such as an individual profile EPG such as “Alice's suggestions”. For example, a phone and/or remote control (or combination of the two) can have referrals to look up “Alice's suggestions” EPG as contained on the reference server.

The authentication of access to “Alice's suggestions” EPG is enabled to take place through the referral by touching of one phone and/or remote control (for example, Alice's mobile phone) to another phone and/or remote control (for example Bob's mobile phone) to pair the phones and allow access to “Alice's suggestions” by agreeing to allow access by following the authentication dialogue screens on the paired interfaces of the phone and/or remote control.

For example, Bob's mobile phone/remote control has the linkage access to Bob's EPG stored on his phone or elsewhere. Likewise, Alice's mobile phone/remote control as the linkage access to Alice's EPG. When Bob's mobile phone touches Alice's mobile phone, they can give reciprocal rights to each other's EPG's.

Real-Time “Share the Moment”

A STM event can also take place as a dynamic instruction from a social network peer member to another member or group as a whole. For example, Alice wants to STM with regard to a news item where she is featured in the free to air broadcast of the news—it is her 15 seconds of frame! Alice sends an STM event to all her social network peers from a dialogue box on Alice's screen to share the current news broadcast. Alice's cSTB receives the instruction and sends the instruction to all her social network peer cSTBs to turn on picture in picture. This picture in picture can take place through the following means:
1—command is sent to STM by Alice, via TCP IP, to a set top box in a remote location where Bob is located and logged in, which instructs the set top box to open a picture in picture on Bob's digital display to play the STM that is being broadcast;
2—as above except STM is retrieved from Bob's set-top box Personal Video Recorder (PVR);
3—as above except STM is retrieved from Alice's set-top box PVR; or
4. as above except the STM is retrieved from a reference server.

There is no public redistribution of the Content that is presented in “share the moment”. The set-top box has a personal video recorder (PVR) that places a delay for a time period, as nominated, such that shared the moment can be retrieved from either a broadcast or a PVR that recorded the selected “share the moment”.

CMedia Social Networking Features:
In the following arrangement of the preferred embodiment the following features the example features of the social network functionality incorporated into the CMedia are described:
1. The social networking is implemented within the user interface of the cSTB system. It displays the pictures and names of all peers and allows access to the profile information of the peers.
2. To support the video-centric social network. For example, special groups for popular television programs are pre-defined and is enabled be joined by the users. Within such a special group, the Content of this television program is enabled to be discussed. Segmentation information for the given program is made available to all users of the group. Background information coming from the Internet is also made available to all users of this group.
3. The users within a group have access to the television presentation of other users (after allowance) and are enabled present pictures, graphics, audios and videos on the screens of remote users. This allows users to perform joint viewing of media assets while users are at different locations.
4. Users are enabled communicate via audio conferencing with each others. This supports the joint viewing of media assets such as VoIP and video over internet protocol.
5. When new items are provided, there are the means to enable other group members to be informed by the event on the digital display screen.
6. Users are enabled when given access to see the digital display status of what program and what recording their peers are currently watching.

### Detailed Requirements on CMedia Social Networking Features:

The preferred embodiment of the invention has the following arrangement including:
The viewer's digital display set is enabled by the cSTB to:
1) see the current Content-status of all peers;
2) if a invitation from a peer is received, the viewer is enabled to add/reject the invitation; and
3) access all data, upon granting of appropriate permission, from a peer's:
   a) General profile information (preferences, . . . )
   b) Pictures, Music files
   c) Message board
   d) Subscribed groups
   e) Friends of a peer
   f) television profile of a peer
   g) television recordings of a peer
   h) program scheduler of a peer
      (ii) Interactive (online) Communicate with peer:
         Send private message to a peer (instant messaging or mail)
         Recommend recording(s) to a peer
         Switch television program of peer to specific program
         Playback low bandwidth media on peers television and on own television (remote control) (stream data from anywhere on the television set of peer)
      (iii) General communication to a peer (other partner not online)
         Send private message to peer (mail)
         Recommend recordings to peer
         Push low bandwidth media to other peer cSTB
      (iv) Interactive (online) communicate within a group:
         Whiteboard messaging within the group
         Recommend recordings to peers
         Switch television program of peers to specific program
         Playback low bandwidth media on all peers television
      (v) General communication within a group (other partners not online)
         Whiteboard messaging within a group
         Recommend recording to peers
         Push low bandwidth media to other peers television (cSTB)
      (vi) Access all groups that have been subscribed by the user:
         Communicate in realtime within the group
         Watch overall status of these users
      (vii) Events that are immediately displayed on television:
         New information is added by the user
         television status is changing by the user
      (viii) Management of own media:
         Local pictures, MP3, videos is enabled be added/deleted to/from the users own profile

Advertising in a Social Network

Identifying and rewarding social networking campaign, for example, an. SMS campaign, is enabled in another arrangement of the preferred embodiment.
1. Social network—share control of the box “did you see that program last night?”
2. send me a link which place the discussed program into a friend's so that a personalised program guide appears titled: “Alice's suggestions” & other selections such as “Joseph suggestions” & “Mark's suggestions”. The recipient may not need all suggestions, or like all suggestions. Thus the recipient of these suggestions can keep, view or delete these suggestions EPG's.
3. When a viewer is watching a program, such as a foot ball match, and in the last five minutes of the game the viewer can click on a sharing command button and broadcast it to their social peers that have an interest in this highlight of the match. Other peers can receive this highlight of the match in real time on their PCs or TVs in a picture-in-picture box as set up by the recipient's preferences.
4. The match is enabled to be sponsored, for example, by Toyota, where the “share the moment” video clip is shared with friends and the advertisement will also be shared with those friends.
5. This social networking broadcasting as the last five minutes of the football match with the audience captive. This enables advertising to be broadcast to a specific target group “at the moment” when the audience is receptive to the advertising. This is like viral marketing where people would like interests are sharing the Content in such a way that the advertisement as the aspects of being similar to a referral by word of mouth.

Advertises can take years to know how to use, and the underlying lying rules of use; for this form of advertising. The STM is implementing the rule is without requiring copious analytical metrics.

The model being used is a shelf space model where there are certain pieces of information that are given a priority. For example, John McEnroe makes the semi-finals and Adidas shoes have sponsored John McEnroe. Then, every time, John McEnroe serves an ace, an advertisement is added to an additional graphics plane or will appear on the main viewing screen as a watermark.

This priority advertising is enabled to be based on an auction basis and/or a retention basis, such that an advertiser can retain all advertising space. For example, when John McEnroe serves, this advertising space is retained by a particular sponsor, who can be paid by Adidas. However, if John McEnroe does not make the semi-finals, then, Addias will only pay the retainer, and not pay the advertising fee since the advertisement is not shown.

The model can also be used in the following way: There can be a cost of five cents per showing of a specific advertisement to an adult target male—which is a pre-pay system, much like a traditional rate card. However, there can be different rates the different viewers; therefore, the ability to access different audiences allows a differential rate card to be produced. For example, $1—can be paid for a sustained view by Alice. However, $1.50 can be paid for a sustained view by Bob because he does the shopping.

Such a payment system is enabled to be at a different rate, if there is a subsequent conversion to use off the e-commerce platform via the targeted viewer interaction to result in purchase.

Social Networking Chat Room

If the user's profile is a member of a chat room, then they can communicate through various communication mediums. For example, if Alice is travelling on a train, Alice can communicate with the chat room by having a port open for voice-over IP communication using TCP/IP over the GPRS system or equivalent. Alice can have another port open for her avatar to be animated within the chat room. Alice can also reallocate resources to each port, so different priorities for communication can be set.

If there is too much processing resources required, applications to be closed down so it goes back to the least resource hungry communication means. As resources become available again, you can have a greater number of ports and applications opened: VoIP. SMS, Video, MP3, sharing etcetera.

The chat room scenario can be used with “share the moment” and VoIP. For example, a user, such as Alice, can select a “share the moment” on an electronic program guide (EPG) and initiate a chat room environment such as the following:
1. a private chat room set up by Alice,
2. a collective chat room set up by Alice and her social peers; or
3. a public chat room.

The chat room may involve the combination of avatars and aspects of the person so desired to be display. Many mobile phones are now equipped with cameras and cameras can be connected to the STM for the IPTV platform.

For example, the profile of the user, such as Alice's profile, may allow Alice's face to be presented with a particular body and/or clothing within the chat room. Alice's face may be filmed by the camera such that only Alice's is portrayed within the chat room with a body and other surrounding elements, for example, on the digital display a nightclub environment may be displayed. The elements surrounding Alice's face are a virtual environment portrayed in on the display of the chat room.

The virtual environment with elements of the individual fused with a virtual environment which can be viewed by Alice and her social peers enables an additional means of advertising to be displayed. For example, a sequence of different eye glasses can be displayed and worn by the user Alice within any environment Alice desires. Consequently, eye glasses can be worn in a night club environment, a dinner party environment, a formal environment etcetera. Furthermore, Alice can try glasses of her linking and ask the opinion of their peers as to whether the glasses are suitable or otherwise. Alice can perform these shopping tasks with her friends without leaving her home environment. Additionally, Alice can try on a series of clothes within the backdrop of the event that Alice and her friends are going to attend—be it the opera, circus, nightclub, restaurant and, ask the opinion of their peers as to whether it is suitable.

This is a form of dynamic advertising allows the advertiser to sell goods in an environment that elements that are virtual and real simultaneously. For example, the trying of different glasses frames allows the user to try a huge variety of frames without the inconvenience of the seller having to supply all the stock in a real physical environment. It also allows the user to seek the opinion of trusted (or mistrusted) peers in a safe environment. This form of advertising is similar to lucid dreaming, where the virtual environment similar to a dream environment; however, the user still has knowledge that they within that altered environment. Furthermore, the advertiser initiates advertisement of products or product suggestion, not under duress, but under selection. This enables an overlay of a “Second Life” or a like application to be available on top of the chat room whilst having the chosen elements of reality fused in.

Personalised Call Centre Support

The sponsor is enabled to create a series of Avatars that have different interactions with the viewer. The viewer's behavioural file will determine what avatars are liked and disliked, so that the purchasing experience, sits comfortably with the recipient. The analytics used within the sales environment of on-screen avatars are similar to the other analytics used with onscreen advertising. Therefore the virtual shopping spree with Alice and her friends can utilise that assistance required through call centre support and appropriate avatars.

Multichannel Display

Most known set-top boxes currently have two channels able to be streamed simultaneously, by having the following formation:

1. one channel being streamed to the digital display (either directly or time shifted via the personal video recorder); and

2. the second channel being recorded to the Personal video recorder.

In a further preferred embodiment, the set top box is not limited by having only having two channels able to be captured at any moment in time. This further preferred embodiment has five graphics planes and two video planes enable by using the TriMedia chip as described in the inventor's earlier provisional patent application: 2007906628 titled “Method, system and apparatus to enable convergent television accessibility on digital television panels”.

Additional problems with the prior art include set-top boxes that provide access to free to air broadcast such as TIVO, which require one subscription per set-top box. Therefore, the user needs to purchase three set-top boxes plus three subscriptions to access multiples of the service. The advantage of the further preferred embodiment set top box arrangement is that each user is able to access a set top box by having a unique login to the set-top box is in any location—the user is able to “hot screen” globally.

The further preferred embodiment enables multiple screens to be displayed on the digital display with multiple applications running. This surpasses the functionality of known set-top boxes.

The graphics planes can have applications displayed for the user including applications such as e-mail, document processing, spreadsheets, EPG, etcetera. Simultaneously the video planes can be showing videos. For example, the main video can be showing a movie of interest, and a second video plane, which may be picture in picture, may be displaying “share the moment”, commentary on stock market results or other information.

The number of graphics planes and video planes enabled can be increased exponentially by increasing the number of set top boxes and digital displays available. For example, three set-top boxes and three digital displays in one room can have fifteen graphics planes and six video planes available. These are all connected via the one broadband access connection.

Additionally, multiple set-top boxes and digital panels can be located in different rooms with different Content showing or conversely, you can have multiple screens within one room with a multitude of images.

The simultaneous broadcasting onto different screens in different rooms, or within the one room can allow the loading of personal Content onto each box and therefore onto each digital panel. Therefore, one viewer can be logged into one screen, such that suitable information is distributed for viewing to that viewer. For example, appropriate music and television programming for a 12-year-old girl with specific tastes is shown, whilst different programming requirements are shown on another screen in a family room, such as a those requirements of 50 year old male who is interested in the share market reports and news.

Synergistic Advertising Across Multiple Communication Channels

Each set top box allows the broadcast of a plurality of graphics planes and a plurality of video planes; such that there are applications open in conjunction with up to multiple video broadcasts per screen. This enables multiple planes of imagery to be displayed along with the additional communication mediums of sound. This enables multiple communication channels to be available to the viewer.

The advertising is enabled to be delivered in a synergistic manner by utilising the multiple communication channels to be available to the viewer and optimising the advertising output to the viewer in a beneficial manner. The analytics of advertising are determined by referencing the profile of the user or viewer and the accompanying behavioural files. When there is no profile of the viewer available, the analytics can still provide advertising to be delivered in a sympathetic form across the multiple communication channels to the viewer.

Sympathetic optimisation of advertising across multiple communication channels can be enabled by showing advertisement and other Content streams which are harmonious to the viewing screens that are displayed through selection by the viewer. This allows synergistic coordination on the Display Planes of Content, along with the accompanying sound output.

Content optimisation allows advertising to operate at multiple levels to reach the target audience and associated audiences. For example, a Lexus car could be advertised, primarily targeting the 50-year-old male. The sale of a convertible Lexis may also require a hat for the purchaser's wife. The ability to stimulate the wife's interest in the Lexis over a barrage of other possible car purchases is where the medium of multiple advertising channels takes place. The wife may never have envisaged wearing a hat and riding in a convertible. Here she is welcomed into a virtual showroom of hats and, after allowing her physical features to added into the showroom environment, as described earlier, can try on the hat and take the car for a ride in any desired fantasy journey. The trying on of different hats can take place on the screen in one vide plane whilst the 50 year old male tests the limits of the car's performance in another video plane (or even on different digital displays if privacy is desired).

The advertisements on separate Display Planes are able to be managed in an optimised manner between all communication channels. For example, the link between the hat and the Lexus car purchase was enabled via separate screens on the same digital display.

Division of the Display Plane on a digital display enables distinct Content and associated information to be displayed, whilst still fusing an underlying theme together, so as to allow harmonious advertising to take place in synergy with the audio output. In a multiple view situation there matrix of advertising is enabled to have one screen targeting one member of the viewing audience, such as with the new hat, whilst another screen is targeting the 50-year-old male, whose desire is to purchase the Lexus. These two screens are enabled to have independent reach to specific viewers, which is simultaneously harmonizing the advertisements to have agreement within the desired purchase.

Another embodiment is the presentation of programming to specific age groups, for example, young adults such as a 12-year-old girl which involves tastes in specific music and imagery, which may be in stark contrast to the desires of her 50-year-old father. The fusion of these dichotomies in desire can be mashed up in the Content (such as programming and advertising) such that there is common ground between the disparate tastes of the parties. This common ground can utilise the humor of the disparate desires, so the outcome is beneficial to both parties.

This embodiment also enables the means of delivering Content to multiple viewers while learning the preferences of individual viewers.

Synergistic Content, such as advertising, across multiple communication channels is enabled to have different underlying business models. For example, a sequence of advertisements can be provided, which might be a different sequence for a different audience based on the audience's behavioural profile. It may be multidimensional in that it covers different times, different places, and different adverting mediums. For example, “choose your adventure” with the Jaguar, such that the viewer's image is incorporated into the seat of the Jaguar on-screen and taken on a driving adventure through whatever experience the viewer so desires.

A plurality of unique Display Planes is enabled to be used for the Content, such as advertising, so that the incorporation of graphics planes and video planes in conjunction with audio can be incorporated together to determine rules of how things should be placed or not placed. This gives rise to, for example, “multiple placement advertisements”. These advertisements can be streamed or targeted on a hard drive of a particular individual having particular behavioural traits, such that the advertisement will be shown at a different place and different time, depending on the different sorts of analytics that are available to the advertiser.

Advertising Synchronisation to User Profile

People's behaviour changes over time, therefore a further arrangement allows the monitoring of changes within the viewer's behavioural file is enabled. This viewer behaviour is tied to the Content, for example the advertising used in the example below, delivered in the following forms:

1. Advertising as people were engaged in choice making scenarios, such that the advertising corresponds in a symbiotic manner;

2. Advertisement in the context of programming—synchronisation to user by the use of meta-tags;

3. Advertising activated before and after programming has run;

4. Passive, audiovisual context “I'm tired”—soothing music, and Bath oil advertisements integrated together;

5. the use of watermark that can be placed on to any form of visual display and carried over any form of protocol such as bit torrent networks.

This optimises the Content such that it is closer to the ideal advertising goals of:
1. never intruding;
2. never interrupting a viewer's chosen program
3. sympathetic to the program Content being delivered; and
4. advertiser is building relationship with viewer.

Content Register

When the Content such as advertising is displayed on a peripheral video or graphic's plane there is enabled a Content register which can detect what Content, such as which advertisements have played and which advertisements are suitable to be played. This Content register is like a shopping basket: if the advertisement has played, then there is no need for the advertiser to purchase another Content slot for the viewer.

The preferred embodiment allows a Content sequence, such as advertisements, to be delivered to the viewer as the advertiser prefers. Therefore, the advertiser can exclude all other advertisements such that viewer only views advertisements by the advertiser and only in order determined by their advertiser. For example, a Lexus can be advertised by the advertiser to only a particular demographic or those with particular behavioural file characteristics. Further, all other advertising to the specific viewer can be blocked so as only to show Lexus advertisements in the sequence that the advertiser so desires. The sequence can be targeted to the advertising budget available: generic Lexus advertisement can be run with low value customers, whilst more specific advertisements can be programmed to a specific form such has being sequence specific.

Another arrangement of the preferred embodiment also enables the incorporation of relationship Content, such as relationship advertising, in conjunction with other criteria such as:—don't take competitor's Content. This is similar to a supermarket's shelf space model of advertising. The platform allows the advertiser to buy a monopoly of specific viewer's viewing access and pay a monopoly premium for such access.

There is also the direct relationship between sponsor, advertiser (or a third party) and viewer such that a matrix model which contains access to Content including:

1 advertising features; and

2. consumer viewing preferences from the viewer's behavioural profile.

These two aspects can be optimised by using specific analytics algorithms to optimise the mach of 1) and 2) above.

The behavioural file is examined with regard to the Content including advertising features to be aligned to specific consumer aspects. This enables the behaviour of the consumer to be aligned with the features of the Content including advertising that the consumer finds endearing.

Further arrangements of the preferred embodiment allow an enhancement of the sponsor experience by providing real-time reports: for example, who's viewing the Content including advertising, what are they converting, when they are viewing the advertising and the relationship between the adverting and the consumer (details set in programming). Further, who skipped on what Content or cancelled the advertising.

Additional arrangements of the preferred embodiment allow an enhancement Viewer participation experience. For example, each viewer can skip or cancel say ten advertisements per month, which they then give feedback to the advertiser who served the campaign, which in turn can be tailored to the viewer's tastes.

Other arrangements include the following:
1. Watch this advertisement and I will pay you $10
2. Coca-Cola—only want advertisements of a specific type to go to 16-year-old females.
3. Prompting behaviour in advertisements—run interactive competition and to now and you can win.

The Content management system via the cSTB can deliver Content including advertising to single demographics and can manage Content including viral advertisements. For example, tell five friends if they validate you get $50. This enables targeting over advertising to everyone. Consequently you have advertising available to only specific people—such as only in the target of 16-year-old girls in specific postcodes.

Smart Analytics.

The set top box enables a campaign management functionality to be put in place with both a:

1. test Content including an advertisement campaign environment; and

2. a post-campaign analysis,

such that analysis enables determination of what worked with specific viewers, as captured on the behaviourial file, at a certain time. Further, how rapidly that demographic receives and responses to Content, including an advertising campaign, changes over time. Therefore, predictive test environments can be run to enable appropriate offer and response returns to be valued.

You can look at different kinds of analytics and have them enhanced:

1 create and assemble a test market;

2 define parameters;

3 write a multiplicity of tests:
a. by democracy;
b. by household;
c. other;

4 perform qualitative analysis to assess responses;

5 trial at different sequence of advertisements with different target groups.

For example with a car:
a. top 10 safety features;
b. crash bars with air bags; and
c. engine response time under particular conditions; and

6 assess which unique features appealed particular audiences.

There might be a need to run the order of hundreds of campaigns before there is an exact recognition, of who the consumer is. Therefore, the behavioural profile of the consumer must be continuously updated. A collection of rules can be used to target individual: trials, pilot, behavioural responses to specific Content including advertising stimuli.

Predictable customer targeting can be used in conjunction with the viewer, enabling to turn on or off Content including advertising. For example, this enables the advertising to be molded from a statistical model to an individual model, because statistically stimuli of a certain type may be acceptable to the majority; however, not to the minority, for which it may be distasteful. The subtle differences can be determined by giving the user control of the advertising, whilst at the same time, involving the viewer to be interactive, with the advertising, instead of being a passive viewer.

Content Delivery Via Viral Marketing Enabled Through the Social Networking Parameters

Viral marketing campaigns are enabled to target network structures, such as specific social peers and community hubs. Individuals who are central within social networks, blogs etcetera are very valuable to the advertiser/third party and therefore are often used within test campaigns.

Typical individuals of value are early adopters and trend setters, which may be providing feedback on advertising or, alternatively, providing information to advertisers that has not already been considered.

Subtle trends can be identified in small pockets of communities, which may be specific subcultures. These trends can become popularised in a short time. It is important for product advertising to capture the elements of these trends. Therefore advertising must capture information as well as discerned what is liked and what is disliked on continual basis. This advertising house capturing of future trends can also be monitored via capturing elements of what is being sent to and from individuals in small representative peer groups. This is particularly important when capturing trends in moods or caught in the moment, social networking clippage and so on. The social networking platform combined with advertising management can capture this detail as required.

Content including advertising positions that are retained (see John McEnroe example above) in programs that are viewed by the target group are important in that the advertising position must coincide with an event in the program, whether or not it is foreseen as likely to happen. Therefore, events more likely to take place can be retained no matter what form of event it is. For example, an unruly fan(s) at the football, tennis or whatever event can be retained, therefore, video clippage of say, who is disturbing the game or is being calmed down by officials, can bring up an advertisement, for example, stating “Staying cool with CoolCola may have been better!”

The mood of Content including the advertisement is matched to the mood of the environment. As discussed previously, when the screen is in passive market and the music channel is active or alternatively, when “Share the moment” has an advertisement displayed to social networking group. For example, the Toohey's “great tries” will buy advertisements across a series of games in anticipation that a certain number of great tries will take place. The STM events is what decides these great tries and therefore the event is enabled to be determined by the recipient social network. This determination will take place by seeing the incidence or threshold events of sending and receiving these STMs. For example, selling advertising for insurance might take place when a cyclone threat or damage occurs. This advertising may only take place when the STM events reach a specified threshold.

Content Serving

The combination of having individual rules contained in the behaviour file and targeting rules contained in the Content including advertisement server allows an effective matrix to work with more determinative outcomes.

The serving of targeted Content including advertisements to identify key moments such as:

1. days of the week;

2. time of the day;

3. sports event (or other program, watched by particular demographic); and

4. the placement of a particular product.

The analytics is enabled to be determined via rural rule-based systems, for which particular rule templates are produced and variations of those templates, such that viewer's behavioural tastes are constantly challenged and continuously updated.

How Specific Viewers are Determined

The profile of a particular viewer is determined as they enter the region surrounding the interactive television:
1. Voice recognition: the cSTB and/or remote control handset is enabled to recognize specific voice codes.

The screen may only be watched for a period of three hours per day. However, the screen can remain on for 21 hours per day so as to provide a visual display in the form of art and background music. Statements by the viewer in the room such as “I'm tired”, or “I'm upbeat” can be used to trigger the mood of the music played and the visualisation displayed on the screen. Simultaneously, with this expression of the viewer's mood, the viewer's mood profile can be recorded into the viewer's behavioural file by the box.

The set-top box is part of the domestic appliance experience. That is, suggestive Content including advertisements are enabled to be displayed when particular mood expressions are noted. Alternatively, different expressions in a voice (a sigh, a series of pauses are indicate tiredness, whereas a rapid series of voice expressions can indicate an upbeat mood) can also trigger particular moods being expressed on the screen.
2. A handset can also recognize the user through a biometric hand print recognition or, alternatively, the punching in of a series of codes.

The advantage of this viewer identification is that digital display can personalise screens and events can be given to the viewer such as an electronic program guide that is suitable to the viewer's likes and dislikes.

The behavioural file is enabled to be modified from the history of viewing Content, the advertisements shown, and the corresponding interaction/response from the viewer, and/or the user's choice with viewing particular programming and other events.

For, example, if the viewer is known to be a Toyota consumer then reminder advertisements can be served in conjunction with other events that are being displayed. For example, if a car breakdown takes place during a movie, then an advertisement reminder is shown: your car is due for service today. Subsequently, the set-top box can send reminders in the form of e-mails, SMS, etc notifying the recipient that “nothing is urgent this morning, therefore, it is a good time to drop your car in the servicing”.

Within these scenarios, the sponsor is not trying to sell products but providing information regarding services that the consumer may require reminding of.

The additional advantage of having the voice recognition used to identify the profile of the person watching the screen is that it can help determine the distance that the viewer where he is from the screen's microphone. Once this distance is known, the lip-syncing can be tuned such that the sound and visual display is harmonious. This lip-syncing tuning can be automated and is described and defined in earlier patents lodged by the inventor Colin SIMON. Likewise, the Display Planes are described and defined in earlier patents lodged by the inventor Colin SIMON (the applicants are currently awaiting the PCT application numbers for these specifications).

As will be further appreciated by those persons skilled in the art, the present inventive method and system affords distinct advantages not previously available to vendors relating to the delivery of Content including advertising to subscribers. In this aspect, the present invention provides novel methods of conducting an array of business functions for the purpose of exploiting the business of the inventive subject matter.

Although the invention has been described with reference to the exemplary and specific embodiments thereof, it will be appreciated by those skilled in the art that the invention will be may be embodied in many other forms without departing from the scope of the invention.

Furthermore, to the extent that the term “includes” is used herein the detailed description or the claims, as such term is intended to be inclusive in a manner similar to the term “comprising”, “having”, and its grammatical variations, in the inclusive sense and not as “consisting only of” when employed as a transitional word in a claim.

1. A Content management and delivery system for an ITV Platform including:
a. a data input means for receiving data from a plurality of data sources including:
i. a distribution source, including any combination of satellite, free to air and cable TV;
ii. a network source, including any combination of:
A. the interne;
B. a public network;
C. a private network; and
D. a network device enabling access to communication technologies;
iii. a data storage medium source, including any combination of:
A. a DVD;
B. a blu-ray disk;
C. a CD;
D. an iVDR;
E. a hard drive; and
iv. any combination of the above;
b. a data selection and processing means for selecting data from said plurality of data sources and processing said selected data; and
c. a data output means for delivering said processed selected data to a plurality of Display Planes, wherein each of said plurality of Display Planes is:
i. individually output via a processor;
ii. received on a Display Means; and
iii. independently written to said Display Means;
such that data received from a plurality of disparate data sources is enabled to be displayed on one or more of said plurality of Display Planes on said Display Means and selectively activated or inactivated according to preference.

2. A Content management and delivery system for an ITV Platform according to claim 1, wherein said data selection and processing means includes a process of extracting data from said data input means and said data output means to build a behavioural file for a user of said ITV Platform, wherein said behavioural file includes data about said user's:
(a) reading habits;
(b) listening habits;
(c) viewing habits; and
(e) any combination of the above,
to provide profile data for said behavioural file.

3. A Content management and delivery system for an ITV Platform according to claim 2, including a data control means to enable selection of:
(a) said data input means;
(b) said data output means; and
(c) a combination of the above.

4. A Content management and delivery system for an ITV Platform according to claim 2, including a unique identifier for each user of said ITV Platform, wherein said identifier includes any one or more of the following:
(a) a login;
(b) a password;
(c) a MAC address;
(d) an IP address; and
(e) a chip ID.

5. A Content management and delivery system for an ITV Platform according to claim 3, wherein said data control means enables selection of data input and/or data output according to said user's behaviourial file, including selection of one or more of the following:
(a) Content to be received;
(b) the timing for receipt of said Content; and
(c) the medium for receipt,
such that said selection is enabled to be adjusted according to said behavioural file so that Content delivery to said Display Means, including advertising or sponsored Content, is enabled to be adjusted according to said user's behavioural file.

6. A Content management and delivery system for an ITV Platform according to claim 5, wherein said data control means enables said Content to be:
(a) deleted;
(b) substituted;
(c) time-shifted;
(d) repositioned;
(e) re-fashioned;
(f) reinserted; and
(g) one or more combinations of (a) to (f) above,
with alternative Content.

7. A Content management and delivery system for an ITV Platform according to claim 6, wherein said alternative Content is selected according to said user's behaviour file.

8. A Content management and delivery system for an ITV Platform according to claim 7, wherein selection of said alternative Content includes reference to said user's behaviour file to determine a degree of closeness of said selection to any one or more of the following:
(a) said user's individual choice(s);
(b) past viewing habits,
(c) purchasing habits;
(d) participation in loyalty schemes;
(e) user interests indicated by habits or choices made by said user; and
(f) information harvested from peers that have communicated with said user, using any of the means interfaced with convergent television.

9. A Content management and delivery system for an ITV Platform according to claim 1, including a selection means to enable user participation in Content delivery.

10. A Content management and delivery system for an ITV Platform according to claim 9 wherein said selection means includes a means to incorporate a user characteristic within Content.

11. A Content management and delivery system for an ITV Platform according to claim 10 wherein said user characteristic includes any one or more of the following:
(a) said user's avatar;
(b) said user's image; and
(c) said user's voice.

12. A Content management and delivery system for an ITV Platform according to claim 9, wherein said selection means includes a means for said user to select any one or more of the following:
(a) a Content theme;
(b) a Content source;
(c) timing of Content delivery; and
(d) proximity to other Content.

13. A Content management and delivery system for an ITV Platform according to claim 1, including:
(a) a ranking means for ranking Content; and
(b) a rebate allocation means for allocating a charge to said Content, wherein said charge includes:
i. a fee;
ii. a discount;
iii. a rebate on a purchase price of an advertised item; and
iv. any combination of i to iii above.

14. A Content management and delivery system for an ITV Platform according to claim 9, wherein said selection means includes a means for game play as a method for managing delivery of said Content.

15. A Content management and delivery system for an ITV Platform according to claim 14 wherein said means for game play requires user interaction.

16. A Content management and delivery system for an ITV Platform according to claim 14 wherein said means for game play includes:
(a) means for a user to perform an action;
(b) means to record said user's action; and
(c) means to match said user's action with an outcome;
such that said user's action determines what Content is delivered.

17. A Content management and delivery system for an ITV Platform according to claim 9, wherein said selection means includes a user characteristic incorporation means, wherein said user characteristic incorporation means includes:
(a) a means for recording a user characteristic; and
(b) a means for displaying said user characteristic,
such that said user characteristic is enabled to be incorporated into Content in a manner that enables user interactivity.

18. A Content management and delivery system for an ITV Platform according to claim 9, wherein said selection means includes an environment incorporation means, wherein said environment incorporation means includes:
(a) means for recording a user's environment; and
(b) means for displaying said user's environment
such that said user's environment is enabled to be incorporated into Content in a manner that enables user interactivity.

19. A Content management and delivery system for an ITV Platform according to claim 9, wherein said selection means includes a social networking means.

20. A Content management and delivery system for an ITV Platform according to claim 19 wherein said social networking means includes:
(a) a means for a user to post Content;
(b) a means for said user to view Content; and
(c) a social network delivery means for said user to send selected Content to one or more members of a social network.

21. A Content management and delivery system for an ITV Platform according to claim 20 wherein said social network delivery means includes means for said user to specify delivery of Content:
(a) at a time chosen by said one or more members of said social network;
(b) at a time chosen by said user, including at a specified time or a specified event;
(c) in conjunction with an event;
(d) on a medium chosen by said one or more members of said social network;
(e) on a medium chosen by said user; and
(f) any combination of the above;
such that said user can instruct Content to be delivered to said one or more members of said social network at a predetermined time, upon the happening of said specified event or at will.

22. A Content management and delivery system for an ITV Platform according to claim 1 including a communication means to enable interactivity between:
(a) a user;
(b) a Content provider; and
(c) members of a social networking community, including said user, a second or subsequent user, and a social network.

23. A Content management and delivery system for an ITV Platform according to claim 13, wherein said rebate allocation means includes a means for applying differentiated charges to said Content according to one or more of the following:
(a) a user's behavioural file;
(b) a time;
(c) proportion of Content displayed; and
(d) membership in a social network.

24. A Content management and delivery system for an ITV Platform according to claim 23 wherein said social network includes a virtual mall.

25. A Content management and delivery system for an ITV Platform according to claim 22 wherein said communication means includes any one or more of the following:
(a) customer support;
(b) a call centre;
(c) customer feedback; and
(d) a virtual assistant.

26. A Content management and delivery system for an ITV Platform according to claim 22 wherein said communication means is tailored to:
(a) a user's behavioural file;
(b) time;
(c) an event;
(d) expertise;
(e) interest;
(f) subject matter; and
(g) any combination of the above.

27. A Content management and delivery system for an ITV Platform according to claim 1 including a Content register for detecting Content played.

28. A method for Content management and delivery in a social network including the steps of:
(a) seeing a current Content status of a peer in said social network;
(b) accessing data, upon consent, from said peer's:
(i) behavioural file;
(ii) message boards;
(iii) subscribed groups;
(iv) friends of said peer;
(v) Content viewing profile of said peer;
(vi) Content recordings of said peer;
(vii) Content schedulers of said peer; and
(viii) any combination of the above;
(c) communicating with said peer, including by:
(i) sending a message to said peer;
(ii) recommending Content to said peer; and
(iii) switching Content of said peer; and
(d) being notified when:
(i) new information is added by said peer; and
(ii) Content status changes.

29-55. (canceled)
